(19) United States
(12) Patent Application Publication
(10) Pub. No.: US 2010/0327626 A1
(43) Pub. Date: Dec. 30, 2010

(54) Chassis of a Passenger Motor Vehicle

(75) Inventor: Karl-Heinz Baumann, Bondorf (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/808,996

(22) PCT Filed: Dec. 3, 2008
(86) PCT No.: PCT/EP2008/010210

§ 371 Date: Sep. 14, 2010

(30) Foreign Application Priority Data
Dec. 19, 2007 (DE) 102007061210.0

(51) Int. Cl. B62D 21/15

(52) U.S. Cl. 296/187.09

(57) ABSTRACT

A chassis for a passenger motor vehicle has a center front vehicle seat, and a passenger compartment having a front structure disposed in front thereof. Longitudinal beams of the front structure extending from inside each vehicle wheel, and pass into a respective transition region of a respectively associated side sill. A deformation element is disposed on the front sides of each transition regions.

This application is a national stage of PCT International Application No. PCT/EP2008/010210 filed Dec. 3, 2008, which claims priority under 35 U.S.C. §119 to German Patent Application No. 10 2007 061 210.0, filed Dec. 19, 2007, the entire disclosure of which is herein expressly incorporated by reference.

The invention relates to a chassis of a passenger motor vehicle having a center seat.

With passenger motor vehicles which are common nowadays, a chassis is provided in which a front vehicle seat row comprises a driver—and a driver's seat. The chassis of the motor vehicle is designed here correspondingly. The respective vehicle seat or seat occupant arranged on this side is thereby in the region of the deformations during frontal collisions.

Additionally, the foot space region of the respective front vehicle seat is nowadays near the associated wheel housing. With large rear displacements of the front wheel due to for example a frontal collision of a passenger motor vehicle with a low width covering, injuries of the lower extremities are anticipated.

Due to this reason, the deformations or intrusions into the passenger compartment—in particular into the front face—have to be limited without fail. The arrangement of components as for example the steering system, the brake system, and the pedal system on the side of the driver's seat further means a high block formation, which represents a danger of intrusions into the front face of the passenger compartment behind the wheel housing or the associated suspension strut tower with corresponding deformations. Due to this reason, these deformations are nowadays delimited with a plurality of bars, rejection elements or the like, in order to avoid an excessive deformation of the chassis in the front foot space region. This has however the disadvantage that the seat occupants possibly have to be exposed to higher acceleration and force peaks.

From European patent document EP 0 677 002 B1 is furthermore already known a chassis for a passenger motor vehicle, in which a center front vehicle seat and two lateral vehicle seats arranged behind are provided, wherein the passenger compartment is arranged behind a front structure which is largely constructed of flat plates. The passenger compartment is also largely constructed of plate elements, in order to form a chassis hereby.

It is thus one object of the present invention to create a chassis of the above-mentioned type, in which the risk of injuries of the seat occupants can again be reduced considerably.

This and other objects and advantages are achieved by the chassis according to the invention, in which longitudinal beams of the front structure pass into a respectively associated side sill in a respective transition region, with a respective deformation element arranged at the front sides of the transition regions. In other words, the invention first uses the center seat position of the seat occupant of the center front vehicle seat in a specific manner for designing the body shell or the chassis concept in such a manner that larger total deformations are permitted with frontal offset and also side collisions, without the driver or the other seat occupants being put in danger. Rather, with frontal collisions with a low width covering, a larger deformation in the region of the passenger compartment is permitted, as the front vehicle seat is positioned in a corresponding central manner. By virtue of the larger permitted deformations, the average passenger compartment acceleration or the force and acceleration peaks acting on the seat occupants can be reduced considerably.

It is thereby beneficial for the entire concept, that the components of the steering system, the brake system and the pedals are no longer positioned in the near region of one of the front wheel housings due to the central positioning of the vehicle seat, but rather in a central region of the chassis or the front structure in front of the associated central front vehicle seat. This concept is particularly suitable for vehicles whose drive power unit is positioned in a center or rear region of the chassis.

In order to permit or enable the larger deformations in the region of the passenger compartment, respective deformation elements are provided at the front sides of the transition regions, which can extend over a considerable length region in the longitudinal vehicle direction. In other words, additional deformation elements or deformation zones are provided in the outer front regions behind the front wheels, into which zones the front wheel that is respectively strained can intrude in a manner that is especially without danger for the seat occupant—usually the driver. However, also for further seat occupants, which are positioned behind the front seat occupant, a larger risk of injuries does not result by the permitted deformation or intrusion. On the contrary, a larger deformation path can be provided by the deformation elements positioned in the transition regions, so that an average passenger compartment acceleration results, which is considerably reduced. The force or acceleration peaks acting on the seat occupants during a frontal collision can thus be reduced considerably. It shall be mentioned here that these larger total deformation values are not only advantageous for the seat occupants of the vehicle itself, but also advantageous for the respective collision partner.

Finally, by avoiding the block formation of the components of the steering system, brake system and the pedals, the present chassis additional permits the center front vehicle seat to be placed farther towards the front, which benefits the passengers seated behind.

It has further been shown to be advantageous if the transition region with the associated longitudinal beam includes an angle of larger than 110°, and in particular larger than 130°. In other words, with the present chassis, transition regions between the respective front longitudinal beams and the respective side sills are used, which are cranked considerably less compared to the present state of the art. While transition regions from the longitudinal beams to the side sills are provided with chassis which are common nowadays which include an angle of about 90 to 100° with the respective associated longitudinal beams, a much larger angle of at least larger than 110°, in particular larger than 130°, is provided according to the invention. This is in particular due to the fact that a larger lateral deformation will be possible due to the front central positioning of the corresponding vehicle seat. The spaces freed by the larger corrugated inclination of the transition regions can thereby be used for the large-format positioning of corresponding deformation elements, in order to correspondingly absorb energy and to reduce the acceleration force peaks on the seat occupants. As no passengers are provided in the transition regions, the deformation or intrusion of the front wheel there is completely harmless in the case of a corresponding frontal collision.

In a further arrangement of the invention it has additionally been shown to be advantageous if a front foot space extends to about the height of the front ends of the transition regions. In other words, the foot space of the center front vehicle seat can extend very far to the front, so that the vehicle seats behind offer a leg freedom for the rear seat occupants which is also good and spacious.

It is additionally advantageous if the respective deformation element projects laterally compared to the associated side sill. It is thus ensured in a particularly reliable manner that a front wheel moved towards the rear due to a frontal impact for example with a low width covering can be absorbed well by the associated deformation element.

It is further advantageous if the deformation element has a front outside region, which projects to the front with regard to a center region. A correspondingly inclined front wheel can hereby also be absorbed well with a frontal collision. In this connection, it is additionally advantageous if the deformation element has a front outside region, which projects to the front with regard to a center region.

If the deformation element is formed projecting upwards with regard to the associated transition region or the associated side sill, a front wheel moved rearwardly upwards due to a frontal collision can also be absorbed well.

In a further arrangement of the invention, the transition region is formed as a rejection chamfer for a respectively associated vehicle wheel, so that it can be ensured with a complete consumption of the energy absorption capacity of the deformation element that the vehicle wheel does not intrude excessively into the region of the passenger compartment lying behind.

In an alternative embodiment, the respective transition regions are formed as longitudinal regions of an arcuate transverse member, which connects the two side sills. By means of such an arcuate transverse beam, a particularly stiff and favorable connection of the two side sills can thereby be achieved altogether.

With regard to a side impact, the chassis formed according to the invention has also been shown to be advantageous. The new longitudinal beam guide with the transition regions arranged with a larger angle to the associated longitudinal beams namely enables a shorter free length of the respective side sills, so that these have a larger capacity. By means of the larger lateral distance of the front center vehicle seat to the vehicle side it is thereby possible to carry out the side stiffness in a stepped manner. This means in particular that lateral deformation zones can now be formed in a specific manner in contrast to the state of the art known up to now, where the passenger compartment has to be designed laterally in an extremely stiff manner, in order to create a lateral crush zone in the region of the passenger compartment within certain limits. This means that the transverse stiffness of the chassis is now designed in such a manner that an increasing capacity of the side is converted. The side stiffness is only designed in a maximum manner with deformations that endanger the seat occupant.

In this connection it has been shown to be particularly advantageous if the side sills form a respective first lateral deformation zone. A second lateral deformation zone can then be connected on the inside of the side sills, which is for example formed by at least one transverse element, which is designed in a deformable manner at its outer regions and in a non-deformable or stiff manner in a center region. It is thus possible to create a stiff occupant protection zone inside the first or second deformation zone arranged in the vehicle center, which zone caters for a sufficient stability. By means of the two deformation zones arranged laterally behind each other, it can however be achieved that a relatively low acceleration with the correspondingly low force and acceleration peaks results on the seat occupant in the case of a side impact.

Other objects, advantages and novel features of the present invention will become apparent from the following detailed description of the invention when considered in conjunction with the accompanying drawings.

### BRIEF DESCRIPTION OF THE DRAWINGS

FIG. 1 is a sectional and schematic top view of a chassis of a passenger motor vehicle with a passenger compartment arranged behind a front structure, in which a center vehicle seat is provided, wherein the front structure comprises longitudinal beams proceeding on the inside of respective vehicle wheels, which pass into a respectively associated side sill in a respective transition region, wherein a respective deformation element is arranged at the front sides of the transition regions, and wherein the transition region includes an angle with the longitudinal beam that is larger than 110° and especially larger than 130° in the present case;

FIG. 2 is a schematic sectional side view of the passenger motor vehicle according to FIG. 1, wherein in particular the deformation element arranged behind the associated front wheel can be seen at the front side of the associated transition region between the front longitudinal beam and the side sill;

FIG. 3 is a schematic sectional top view of the chassis of the passenger motor vehicle analogously to FIG. 1, wherein the respective transition regions between the front longitudinal beams and the side sills are formed as longitudinal regions of an arcuate transverse beam, which connects the two side sills with one another;

FIG. 4 is a sectionally enlarged top view of the chassis of the passenger motor vehicle according to the embodiment in FIG. 1; and

FIG. 5 is a schematic top view of the chassis of the passenger motor vehicle analogously to FIG. 1, wherein a transverse element is provided, which extends between the side sills, wherein a respective first lateral deformation zone is formed by the side sills and a respective second deformation zone arranged respectively on the inside therefrom, and wherein the transverse element has an essentially stiff or non-deformable center region, which forms an occupant protection zone in particular for the seat occupant of the center front vehicle seat.

### DETAILED DESCRIPTION OF THE DRAWINGS

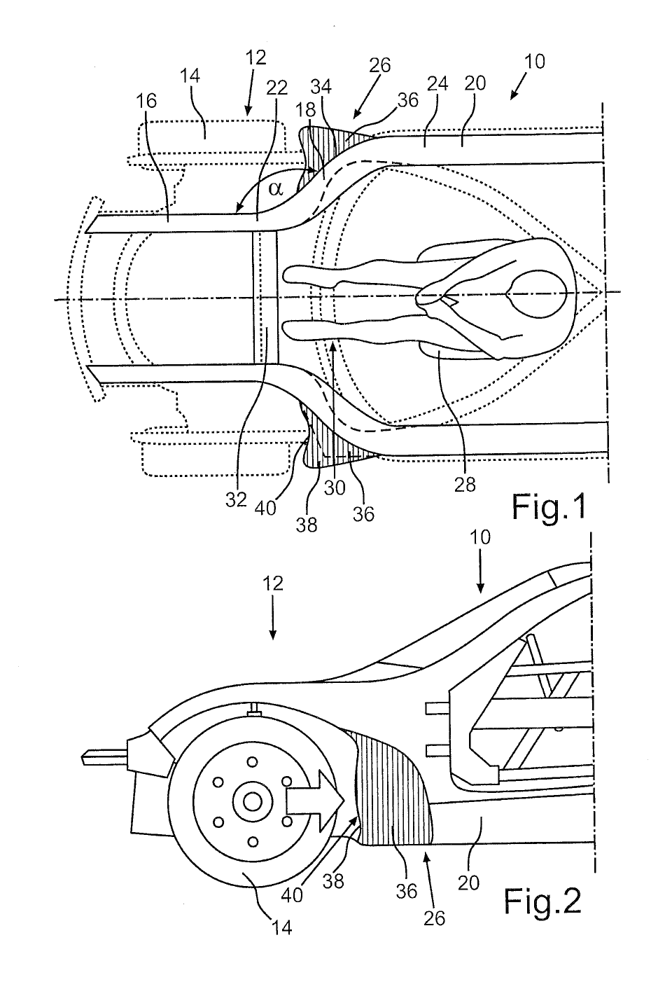

FIG. 1 shows a chassis for a passenger motor vehicle only in an extremely schematic and sectional top view. A passenger compartment 10 can thereby be seen in particular, to which is connected towards the front a front structure 12 forming a crush zone.

In the region of the front structure 12, two longitudinal beams 16 can be seen, which extend in the longitudinal vehicle direction, proceeding on the inside of respective vehicle wheels 14, which beams pass into a respective side sill 20 in a respective transition region 18. In other words, the transition regions 18 form a respective bridge of the rear end 22 of the respective longitudinal beam to the front end 24 of the respective corresponding side sill 20.

A special feature of the present body consists in that the respective transition region 18 includes a respective angle α with the corresponding longitudinal beam 16 that is larger than 110° and especially larger than 130°. In the present embodiment, the angle α is about 135°. The angle α is thereby related to a center extension region of the corresponding of the corresponding transition region 18, which is altogether—in particular in the connecting region to the rear end of the longitudinal beam 16 or to the front end of the side sill—naturally bent slightly. The specialty is however altogether that the transition region 18 includes a much larger a with the associated longitudinal beam 16 than is the case with common vehicle chassis. With these, the angle α between the transition region and the corresponding longitudinal beam is usually between 90 and 100°. It can be seen that a much larger free space 26 results hereby behind the respective vehicle wheels 14 in the region of the passenger compartment 10. The respectively hit vehicle wheel 14 can intrude through this free space 26 during a frontal collision, in particular an offset frontal collision without hesitation without resulting in an endangerment of a seat occupant.

In contrast to the common passenger motor vehicles, a center front vehicle seat 28 is presently provided. The front seat occupant—usually the driver—thus sits centrally in the vehicle center. Furthermore, two rear vehicle seats are provided with the present chassis, namely offset to the rear and laterally to the front vehicle seat 28. The region laterally of the front vehicle seat 28 thus serves as a foot space for the seat occupants of the rear vehicle seats.

Due to the previously described fact that the respective transition regions 18 form a larger angle α with the associated longitudinal beams 16, the seat occupant of the front vehicle seat 28 sits displaced relative far to the front. A front foot space 30 thus extends up to a front face wall 32 or to approximately the height of the front ends 34 of the transition region 18 or of the rear ends 22 of the respective longitudinal beams 16.

A further specialty of the present chassis is that the an associated deformation element 36 is respectively coupled to respective front sides 34 of the transition regions 18.

The concrete contour of the deformation elements 36 can thereby be seen in particular in connection with FIG. 2, which shows the chassis according to FIG. 1 in a schematic side view. It can be seen thereby in connection with FIGS. 1 and 2 that the deformation element 36 projects outwardly with regard to the respectively associated side sill 20. It is in particular achieved hereby that a vehicle wheel 14 moved rearwardly due to a frontal collision is absorbed in a corresponding safe and reliable manner. The deformation element 36 comprises a front outside region 38 for this, which projects forwardly with regard to a center region 40. The center region 40 is arranged so as to be set back seen in the top view and serves for absorbing the vehicle wheel 14, if it is turned inwards with its rear end. It can further be seen from FIG. 2, that the deformation element 36 projects upwardly with regard to the associated transition region 18 or the associated side sill 20. A vehicle wheel 14 moved backwards due to a frontal collision can hereby in particular be absorbed even then in a good manner, if it is moved backwards upwardly relative to the chassis. Furthermore it can be seen in particular from FIG. 1 that the respective deformation element 36 essentially has a triangular cross section. A large format support at the respective front sides 34 of the transition regions 18 results hereby and a large-surface catchment area, which faces the respective vehicle wheel 14.

The transition region 18 is—as can in particular be seen from FIG. 1—also designed as a rejection chamfer, so that an excessive intrusion into the passenger compartment 10 can be excluded if the deformation element 36 should be consumed completely with a rear displacement caused by an accident. Altogether it can thus be seen from FIGS. 1 and 2 that the central seat position of the front seat occupant creates additional deformation zones due to the respectively created free spaces 26, so that the front wheel 14 loaded during a frontal impact can be displaced backwards without danger for the driver or can intrude into the passenger compartment 10 to a certain extent. The beam structure—formed by the respective longitudinal beam 16, the transition region 18 and the side sill 20—is thereby adapted more to the force flow during the frontal impact and is bent less. Larger deformation values can thus be realized with advantages for the seat occupants, in particular also for the rear seat occupants and also for the collision partner taking part in the frontal collision. The vehicle center is thereby the safest place for the driver. It is additionally obvious from FIGS. 1 and 2, that the offset arrangement with the present chassis is purposely designed in such a manner that larger wheel displacements are possible. Thus, no deformation limitation by occupants in the direct impact region takes place. Rather, a targeted load reduction results by the possible large total deformation.

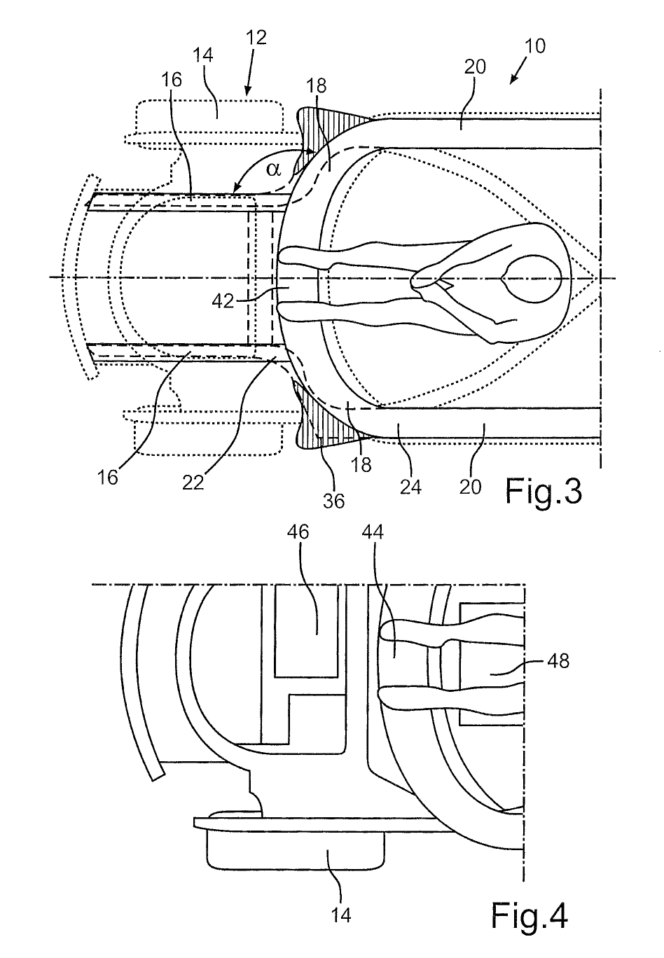

FIG. 3 shows a similar top view of the chassis of the motor vehicle as FIG. 1, wherein a slightly modified version is shown. This is particularly distinguished in that the respective transition regions 18 between the longitudinal beams 16 and the corresponding side sills 20 are formed as a longitudinal region of an arcuate transverse beam 42, which connects the two side sills 20 to each other. The frontal support region is hereby in particular strengthened in that a better lateral connection of the longitudinal beams 16 and of the side sills 20 can be realized by means of the transverse beam 42.

In FIG. 4 is shown the chassis of the passenger motor vehicle in section enlarged in its—seen in the forward direction—left front region. It can thereby be seen in particular that, by the central positioning of the vehicle seat 28—and thus the central positioning of the driver—the positive effect is achieved that components of a brake system 44, a brake device 46 and a steering system 48 are thus also arranged in the vehicle center. While these components usually effect a block formation with a lateral positioning of the driver, which necessitates a corresponding stiff arrangement of the passenger compartment in the front region, the lateral regions of the passenger compartment 10—as explained above—can be designed in a more deformable manner by the central arrangement of the pedal system 44, the brake device 46 and the steering system 48. In other words, these deformation-restricting elements are now arranged in the vehicle center. The avoidance of the pressure formation thus also permits to place the driver in the vehicle center further towards the front, which benefits the passengers behind.

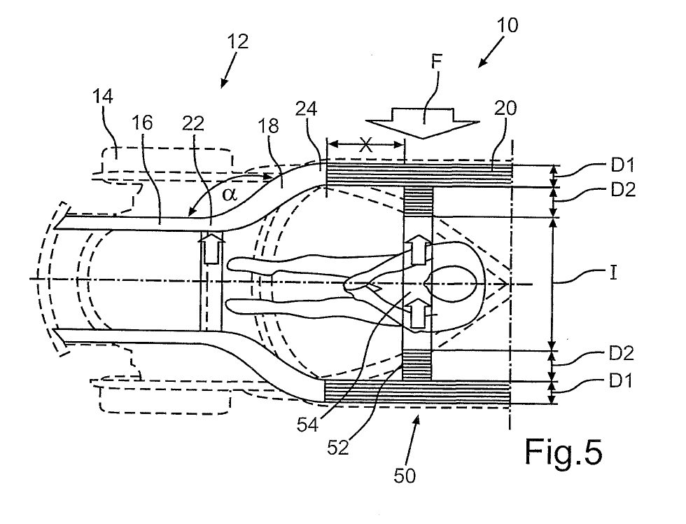

In FIG. 5 is finally shown the passenger motor vehicle according to FIG. 1, wherein its function shall be explained with a side impact with a corresponding accident force F.

From FIG. 5 it can be seen thereby that the side sills 20 respectively form a lateral deformation zone D1, which collapses after the lateral application of the accident force F and the energy absorption. A respective second deformation zone D2 is connected on the inside to the side sills 20, which zone is realized by a transverse element in the present case. This transverse element 50 comprises outer regions 52, which are designed in a deformable manner when absorbing energy. A conceivable design would be hereby that the outer regions 52 are designed in the manner of an impact cup or a deformation element. This would for example be conceivable in that the transverse element 50 designed altogether as a transverse beam has corresponding material weaknesses such as recesses, seams or the like. The transverse element 50, which altogether proceeds in the transverse vehicle direction, is thereby connected to the side sills 20 on the inside. A center region 54 of the transverse element 50 has however an increased stiffness and can essentially not be deformed or is not designed as a deformation element. This center region 54 thus forms a stiff occupant protection zone I arranged in the vehicle center, which shall essentially not be deformed with a corresponding high force application by the accident force F.

The side impact furthermore permits the previously described longitudinal beam guide with the transition regions 18 arranged with a larger angle α to the to the longitudinal beams 16, so that a lower free length X of the respective side sill 20 results between its front end 24 and the support location at the transverse element 50. A shorter lever of the free length X results in this manner, which results in that the side sills 20 altogether have a larger load capacity or a good load distribution in the case of a force application caused by a crash.

By the large lateral distance of the driver to the vehicle side, the lateral stiffness is now designed in a stepped manner in contrast to the previous strategy, in which a maximum stiffness was essentially necessary due to the lateral arrangement of the vehicle seats. That means that the transverse stiffness of the chassis is now designed in such a manner that an increasing load capacity of the side is converted. In other words, respective lateral crush zones are created by the deformations D1 and D2, which can correspondingly be shortened in their length while absorbing energy. Only with deformations endangering the occupants, the lateral stiffness is designed in a maximum manner in the region of the occupant protection zone I, so that a sufficient survival space remains. As a result it is achieved thereby that the entered accident force F can be received in a better manner and that acceleration and force peaks can correspondingly be attenuated. The current strategy of a basically maximum side stiffness is thus expressly deviated from.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. A chassis for a passenger motor vehicle having a center front vehicle seat, a passenger compartment with a front structure disposed in front thereof, and vehicle wheels; wherein:
said front structure comprises longitudinal beams that extend from inside each vehicle wheel and pass into a respective transition region of a respectively associated side sill; and
a respective deformation element is disposed on front sides of the transition regions.

15. The chassis according to claim 14, wherein:
the transition region forms an angle α with the longitudinal beam; and
the angle α is larger than 110°.

16. The chassis according to claim 14, wherein:
the transition region forms an angle α with the longitudinal beam; and
the angle α is larger than 130°.

17. The chassis according to claim 14, wherein a front foot space of said passenger compartment extends up to approximately the height of front ends of the transition regions.

18. The chassis according to claim 14, wherein the deformation element projects laterally with regard to the associated side sill.

19. The chassis according to claim 14, wherein the deformation element has an outside front region, which projects toward the front with regard to a center region.

20. The chassis according to claim 14, wherein the deformation element projects upwards with regard to the associated transition region or the associated side sill.

21. The chassis according to claim 14, wherein the deformation element has an essentially triangular cross section.

22. The chassis according to claim 14, wherein the transition region is formed as a rejection chamfer for the respective associated vehicle wheel.

23. The chassis according to claim 14, wherein the respective transition regions are formed as longitudinal regions of an arcuate transverse beam, which connects the two side sills with each other.

24. The chassis according to claim 14, wherein the side sills form a respective first lateral deformation zone.

25. The chassis according to claim 14, wherein a respective second deformation zone is connected to each of the side sills on the inside.

26. The chassis according to claim 25, wherein the second lateral deformation zones are formed by at least one transverse element that is connected to the inside of the side sills.

27. The chassis according to claim 24, wherein a stiff occupant protection zone is provided which is arranged inside of the lateral deformation zone in the vehicle center.
